(19) United States
(12) Patent Application Publication
(10) Pub. No.: US 2013/0085004 A1
(43) Pub. Date: Apr. 4, 2013

(54) MOBILE BIKE SWING

(71) Applicant: Rise Above Products, LLC, Wyandotte, MI (US)

(72) Inventor: Ronald Richard Thomas, Wyandotte, MI (US)

(73) Assignee: Rise Above Products, LLC, Wyandotte, MI (US)

(21) Appl. No.: 13/632,492

(22) Filed: Oct. 1, 2012

Related U.S. Application Data
(60) Provisional application No. 61/542,214, filed on Oct. 2, 2011.

(51) Int. Cl. A63G 9/00; B23P 17/04

(52) U.S. Cl. 472/118; 29/428

(57) ABSTRACT

A mobile bike swing comprising a base and a first arm pivotally connected to the base. The mobile bike swing also comprises a second arm parallel to the first arm and having a predetermined distance therebetween. The second arm being pivotally connected to the base. The mobile bike swing also comprises a top bracket arranged between the first arm and second arm and a hook arranged generally a center point of the top bracket. The mobile bike swing also comprises a swing connected to the hook wherein the swing allows the bike rider to ride and swing both perpendicular and parallel to the base on which the mobile bike swing is connected.

### BACKGROUND OF THE INVENTION

1. Field of the Invention

The present invention generally relates to a bike swing, and more particularly relates to a mobile bike swing connected to a trailer that allows for bike stunts to be done in a safe manner.

2. Description of Related Art

For many years there has been an activity commonly called BMX rope swing, an invisible half pipe or bike rope swing. This prior art bike swing includes riding a bike wherein a person hangs a rope from a tree. At the bottom of the rope, a ring such as a normal padded bike tire, is attached thereto. This ring hangs about the height of the chest or the mid section of the body of the rider. This ring may act as a harness, which may allow the rider to swing back and forth like a normal tree swing would, except the rider is capable of riding a bike or some similar object, like a scooter, while using the prior art bike swing. The prior art bike swing was a way to do normal bike stunts with far less risk than the use of a traditional ramp. After being strapped into the bike swing harness the rider could ride their bicycle forward and it would pull them up in the air like a swing set and when it does the rider could turn around in the air and land forward and/or backwards. The rider is also capable of peddling on the ground and repeating such a swinging sensation. After repeated use the final result may be that the rope and tire/harness combination will pull the rider up in the air like a swing set with the bike underneath the rider so that the rider could go high into the air in order to perform back to back tricks, just like riding what is commonly referred to as a half pipe or a vert ramp for bicycles.

One problem with the prior art bike swings may be that they have to be affixed to a tree that is stationary and also has other surrounding branches that may create possible hazards to the person using the bike swing. Furthermore, another problem with the prior art bike swings may be that the branch onto which the bike swing rope or chain is connected to may break, thus potentially causing injury to the bike rider during use of the swing.

Therefore, there is a need in the art for a robust mobile bike swing. There also is a need in the art for a mobile bike swing that is capable of being moved to various locations to entertain a crowd by doing bike tricks. Furthermore, there is a need in the art for a mobile bike swing that may have the necessary height to replicate that of a tall tree while being capable of being placed in a more safe environment for the bike swing tricks to be performed thereon. Also, there is a need in the art for a mobile bike swing that has a plurality of ramps attached or adjacent thereto to further enhance the enjoyment of the bike riders performing the bike tricks thereon.

### SUMMARY OF THE INVENTION

One object of the present invention may be to provide an improved mobile bike swing.

Another object of the present invention may be to provide a mobile bike swing that uses a trailer as a base to allow for placement of the bike swing at many different locations.

Yet a further object of the present invention may be to provide a mobile bike swing that is capable of being placed in environments that are more safe for the bike swing riders than the trees of the prior art.

Still another object of the present invention may be to provide a mobile bike swing that includes a plurality of ramps adjacent to or attached thereto to.

Still another object of the present invention may be to provide a mobile bike swing that is easy to assemble and disassemble, thus allowing for mobility of the bike swing to various venues.

Still another object of the present invention may be to provide a mobile bike swing that allows for bike riding both parallel and perpendicular to the base or trailer onto which the bike swing is connected, thus allowing the same swing to either make or not make use of an attached ramp at the same location.

Still another object of the present invention may be to provide a mobile bike swing that includes the combination of a bike swing and a quarter pipe and other ramps attached thereto in the same device.

According to the present invention, the foregoing and other objects and advantages obtained by a novel apparatus and methodology for a mobile bike swing. The mobile bike swing may comprise a base and a first arm pivotally connected to the base. The mobile bike swing may also comprise a second arm parallel to the first arm and having a predetermined distance therebetween, wherein the second arm is pivotally connected to the base. The mobile bike swing may also comprise a top bracket connected and arranged between an end of the first arm and an end of the second arm. The mobile bike swing may also comprise a hook arranged generally at or near a center point of the top bracket and a swing connected to the hook with a tire, tube or other harness attached at the end of the swing rope or cable. The use of the mobile bike swing may allow for bike tricks to be performed at many different locations, both parallel to and perpendicular to the base to which the mobile bike swing is connected.

One advantage of the present invention may be that it provides for a mobile bike swing.

A further advantage of the present invention may be that it provides for a mobile bike swing that is capable of being assembled and disassembled and moved to a different location for various shows to be performed before various audiences.

Yet another advantage of the present invention may be that it provides for a mobile bike swing that uses a trailer as a base making for easy assembly and disassembly and movement of the mobile bike swing.

Yet another advantage of the present invention may be that it provides for a mobile bike swing that has the necessary height and rigidity to mimic that of a tree to which prior art bike swings may have been connected.

Still another advantage of the present invention may be that it provides for a mobile bike swing that includes at least one ramp, such as but not limited to, a quarter pipe ramp connected to the base, thus allowing for a variety of bike tricks to be performed with the bike swing.

Yet another advantage of the present invention may be that it provides for a mobile bike swing that is capable of being placed at a variety of angles with respect to the base, thus allowing for different heights to be achieved by the mobile bike swing.

Other objects, features and advantages of the present invention may become apparent from the subsequent description and appended claims, taken in conjunction with the accompanying drawings.

### BRIEF DESCRIPTION OF THE DRAWINGS

FIG. 1 is a plan view of a mobile bike swing according to the present invention.

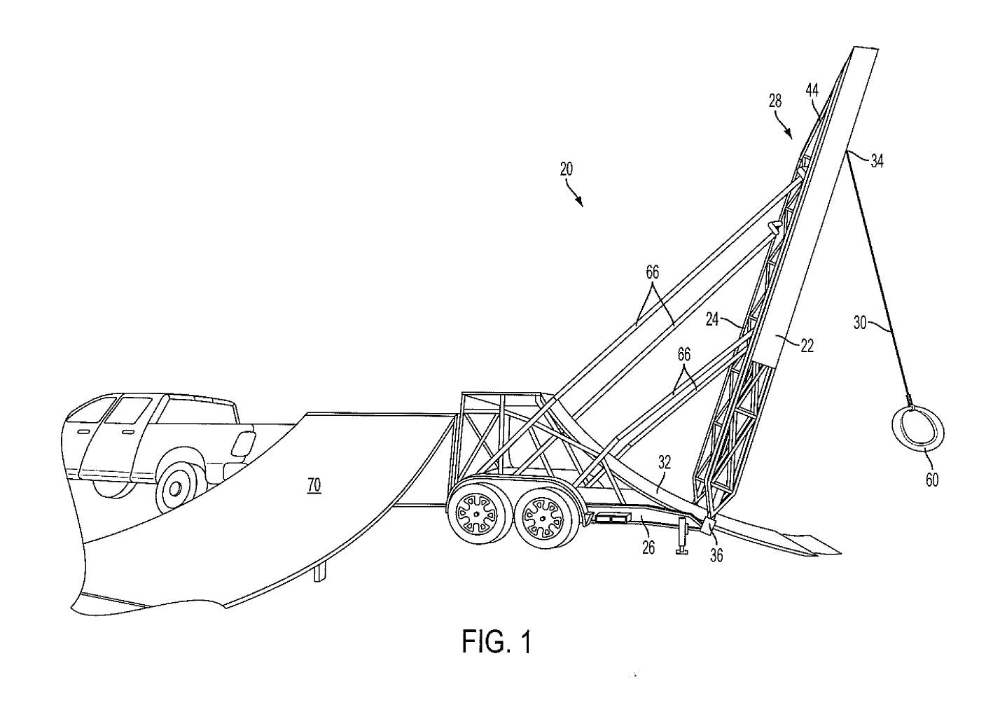

FIG. 2 is a plan view of a mobile bike swing with a rider thereon according to the present invention

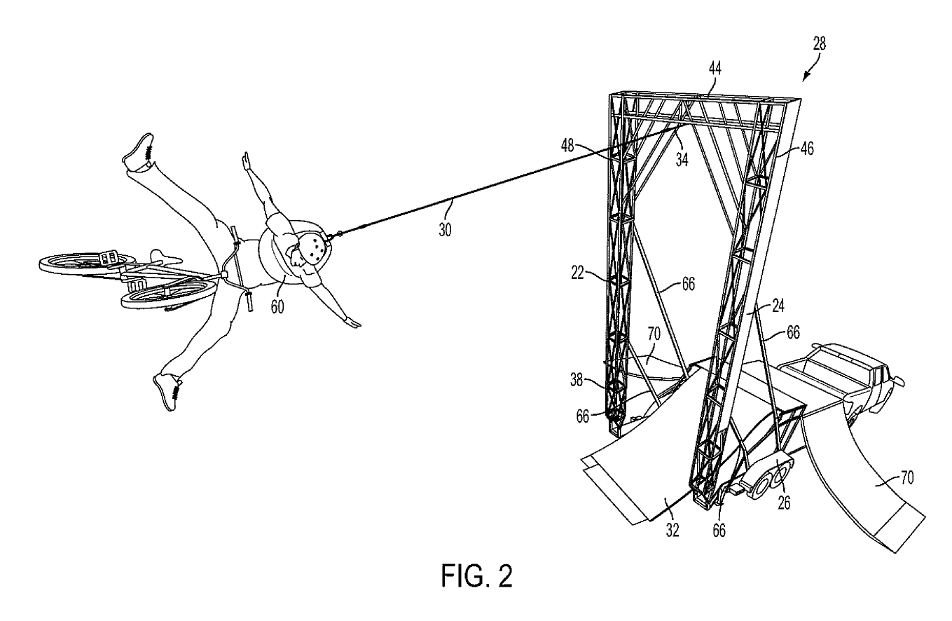

FIG. 3 is a side view of a mobile bike swing stored on a base/trailer.

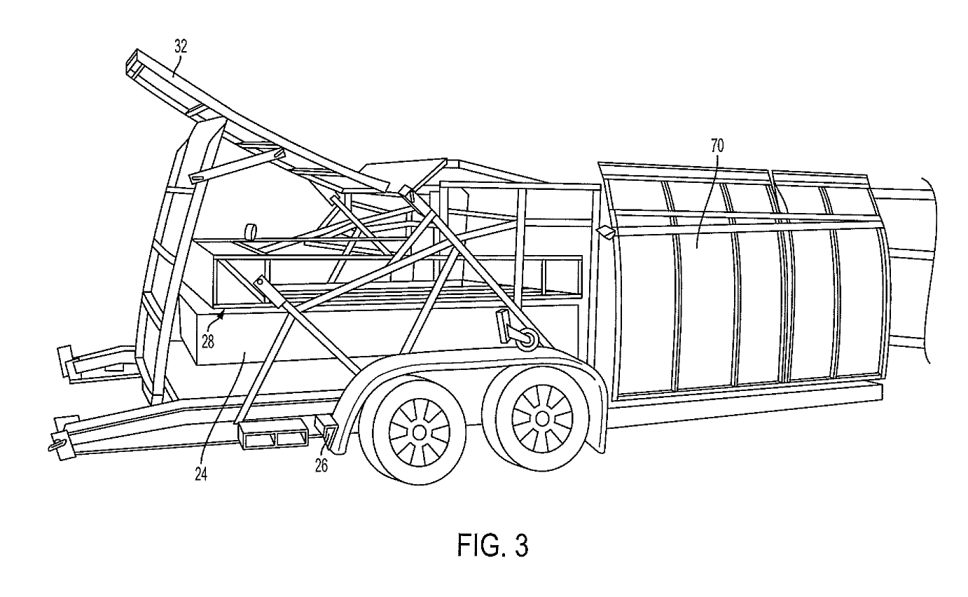

FIG. 4 is a view of a mobile bike swing being removed from a base/trailer.

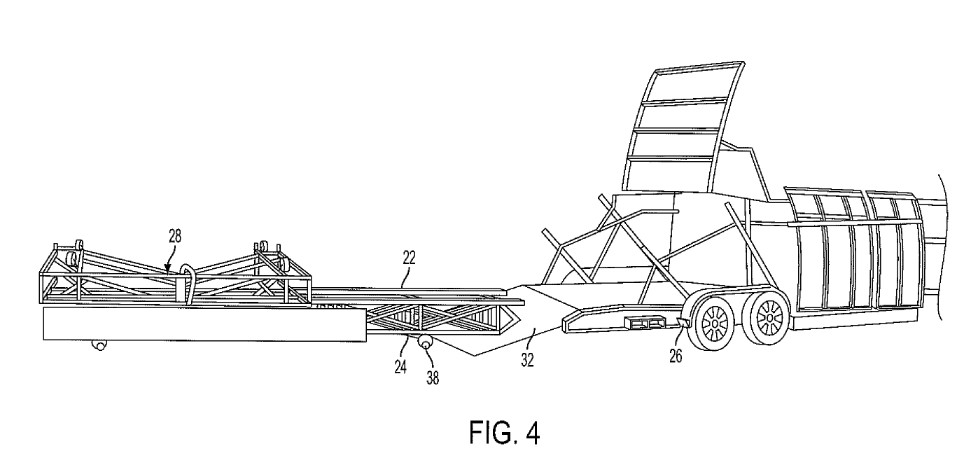

FIG. 5 is a view of the arms of the mobile bike swing and a top bracket.

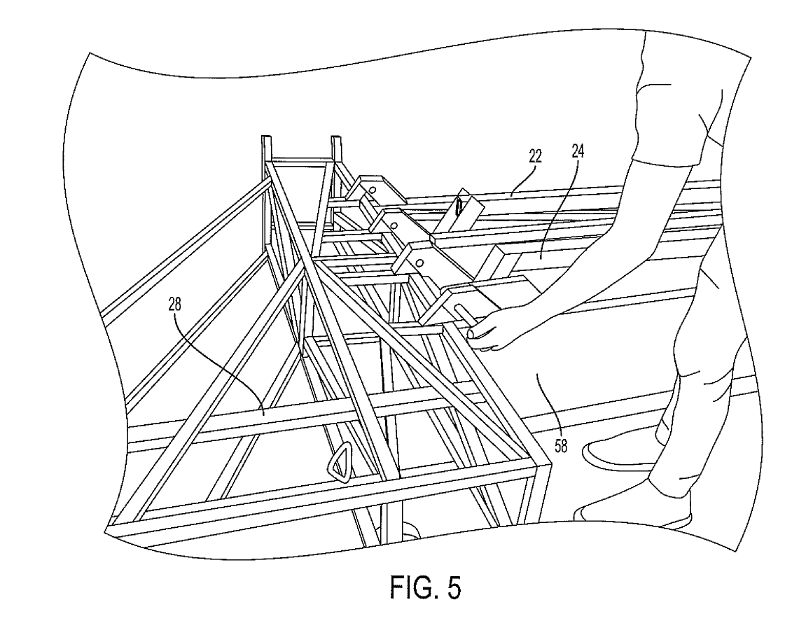

FIG. 6 is an end view of an arm of the mobile bike swing according to the present invention.

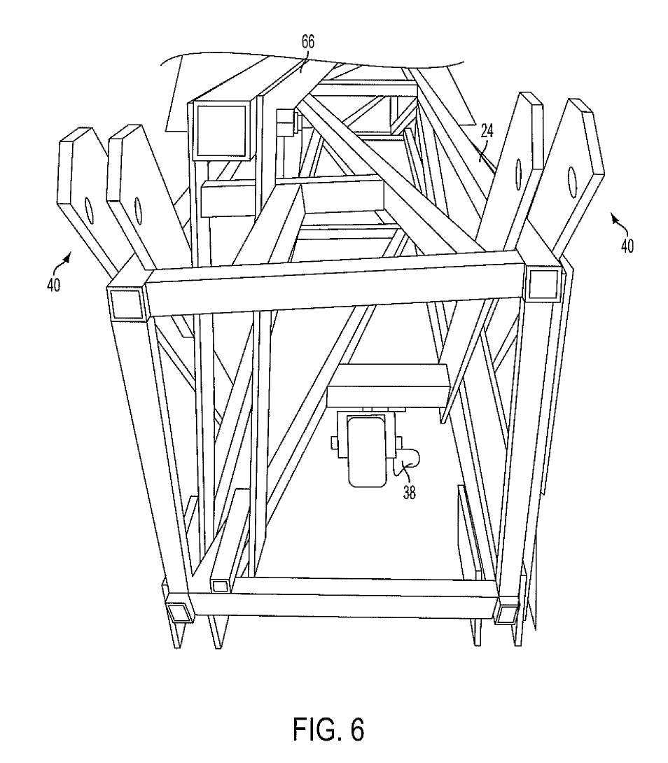

FIG. 7 is an end view of a top bracket of a mobile bike swing according to the present invention.

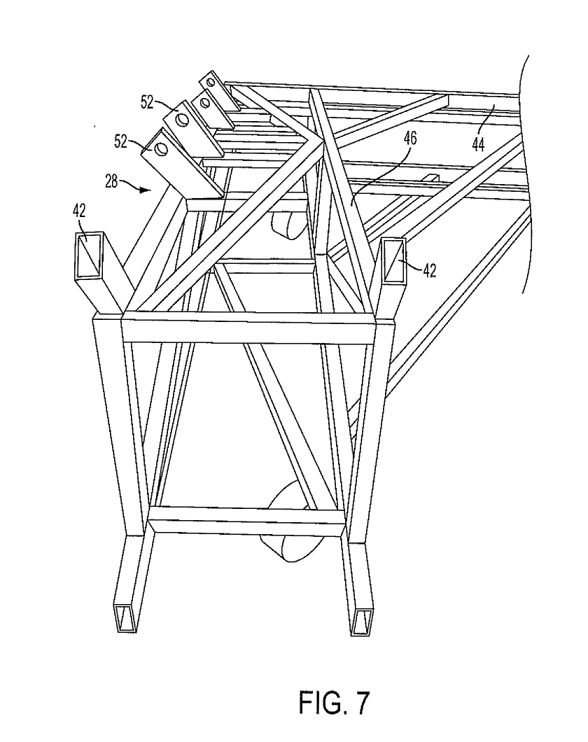

FIG. 8 is a view of an arm connected to the top bracket of the mobile bike swing according to the present invention.

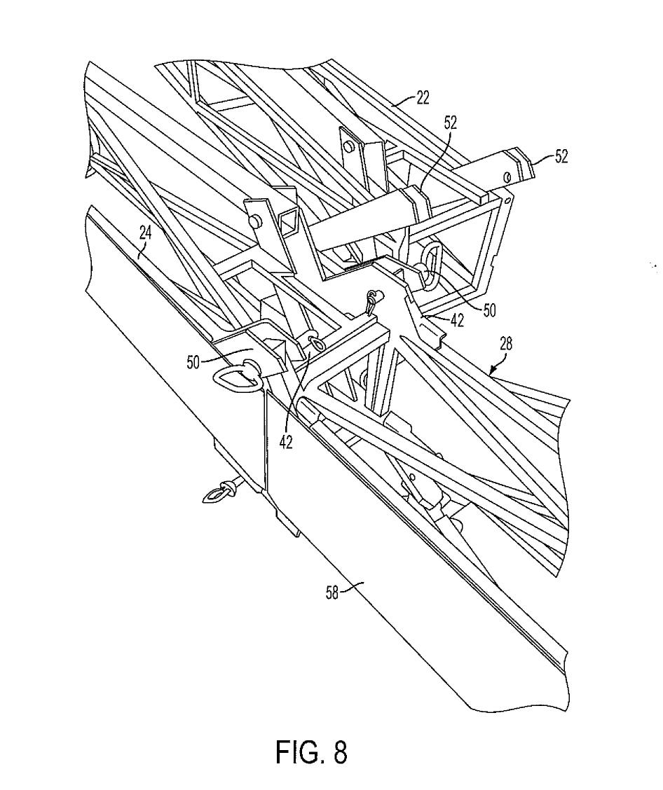

FIG. 9 is a top view of the mobile bike swing assembled according to the present invention.

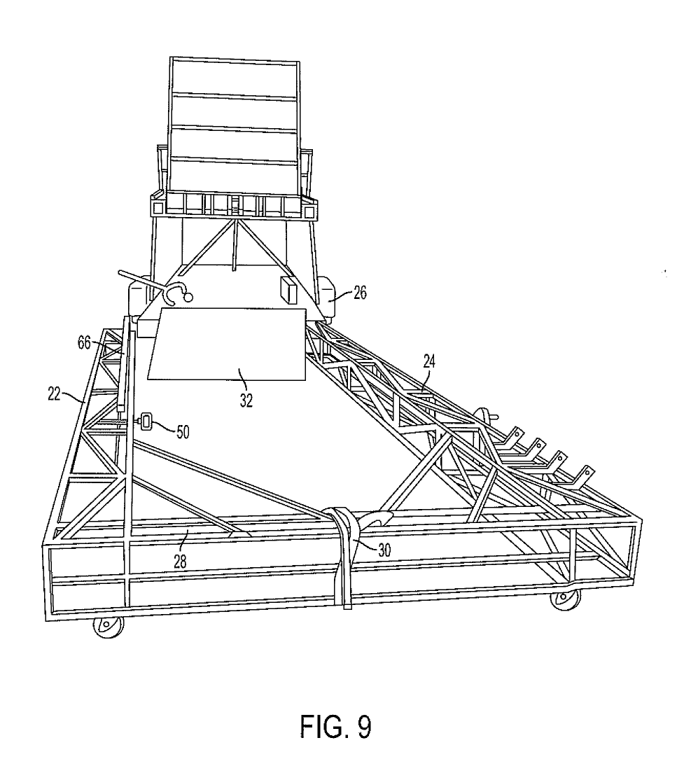

FIG. 10 is a view of the end of an arm of a mobile bike swing and a base.

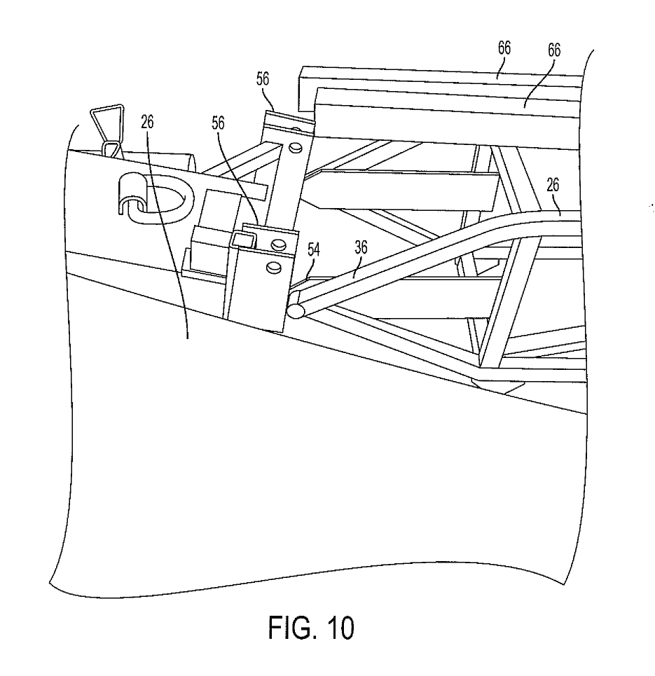

FIG. 11 is a view of the connection between an arm of the mobile bike swing and a base.

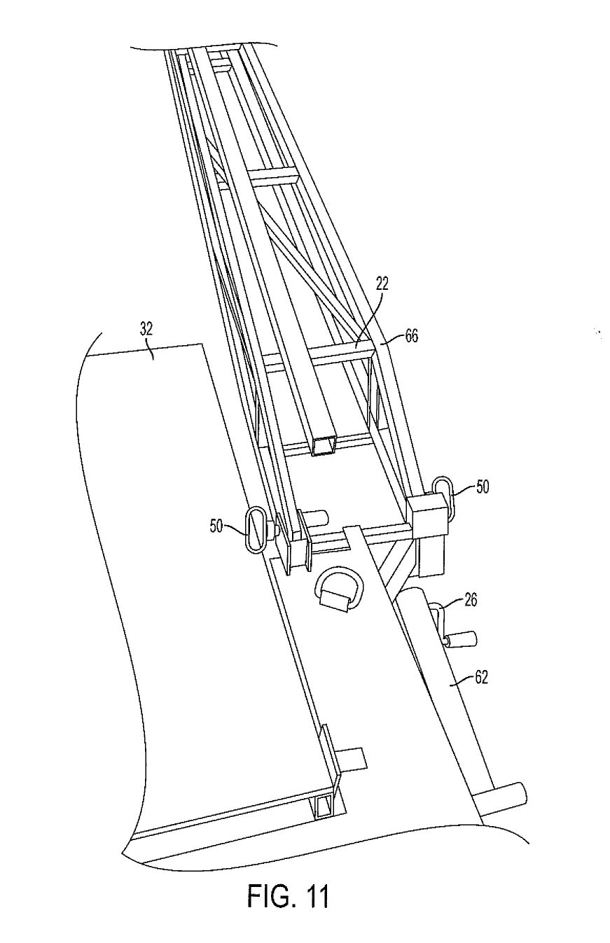

FIG. 12 is a view of the mobile bike swing being lifted to a predetermined height.

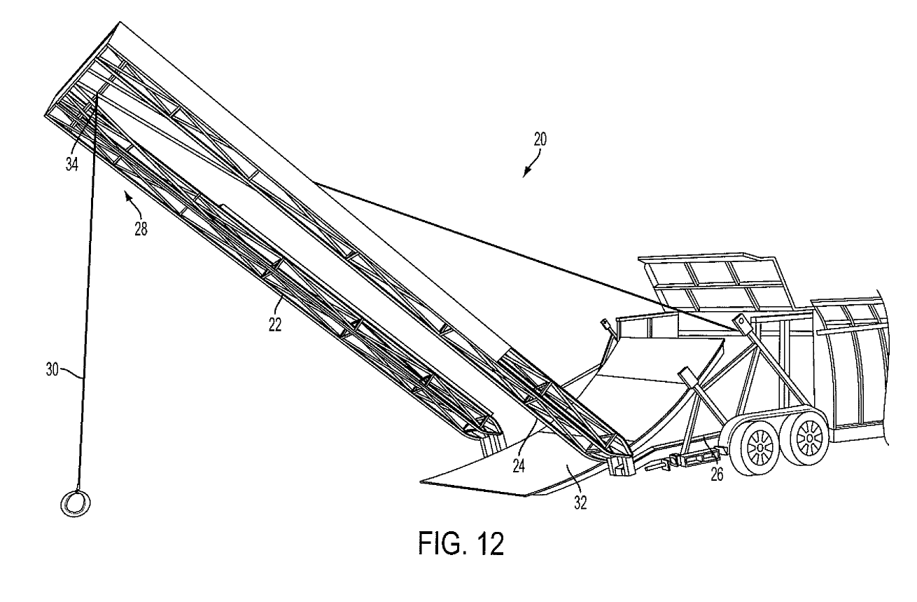

FIG. 13 is a view of the mobile bike swing having mounting braces attached thereto.

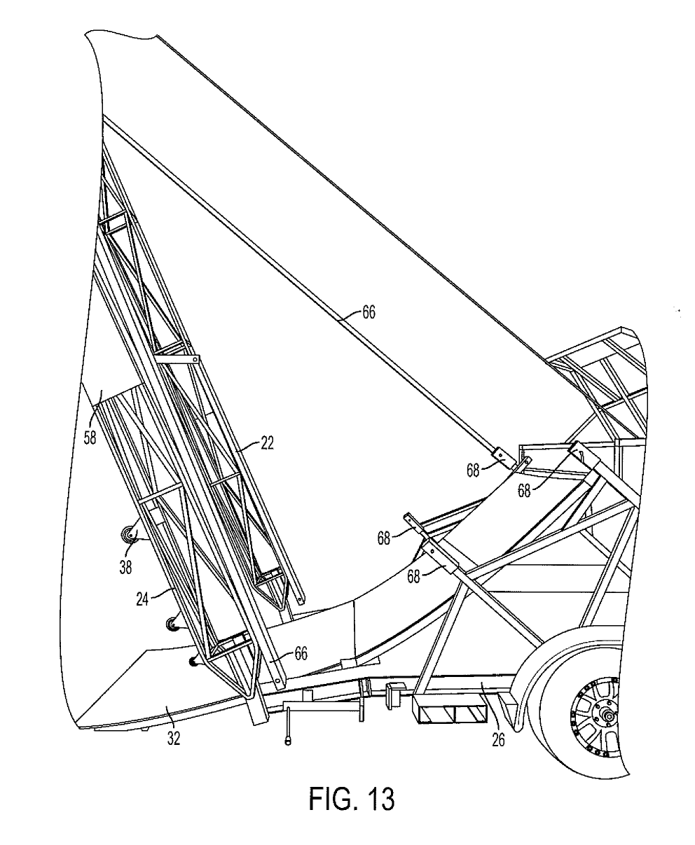

FIG. 14 is a view of mounting braces connected to a base of the mobile bike swing.

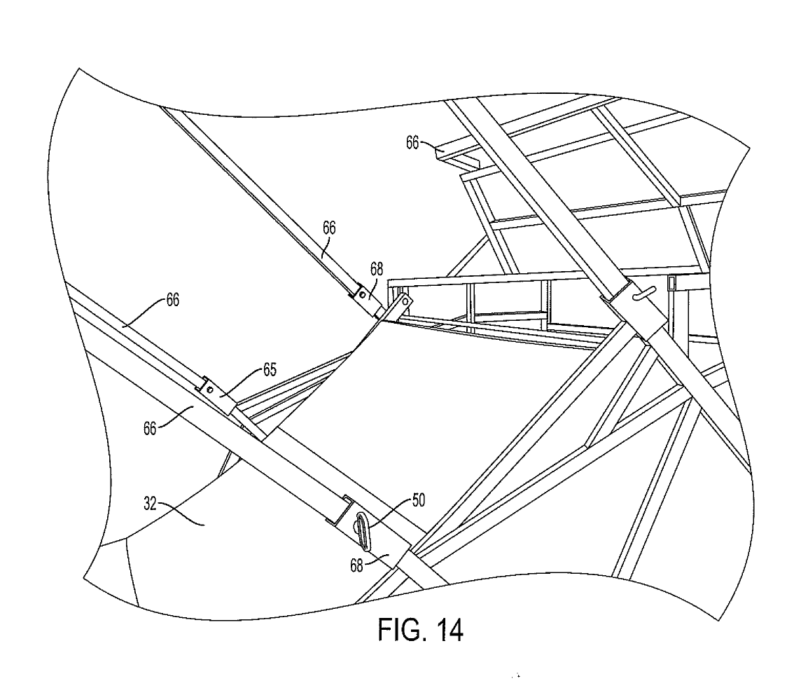

FIG. 15 is a view of the mobile bike swing in its fully assembled or raised position.

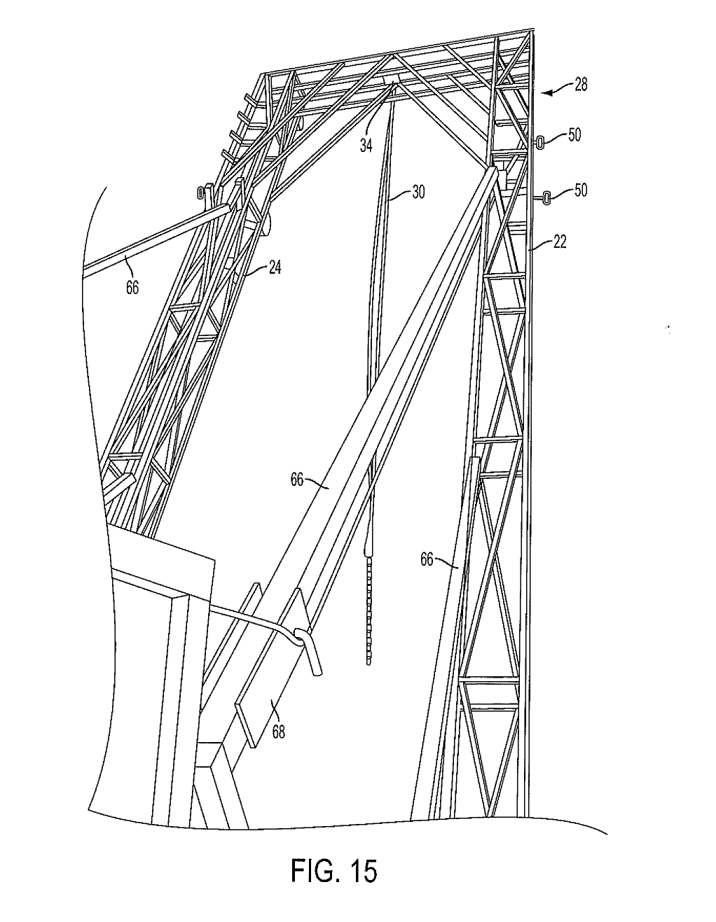

FIG. 16 is a view of a jack stand of the mobile bike swing according to the present invention.

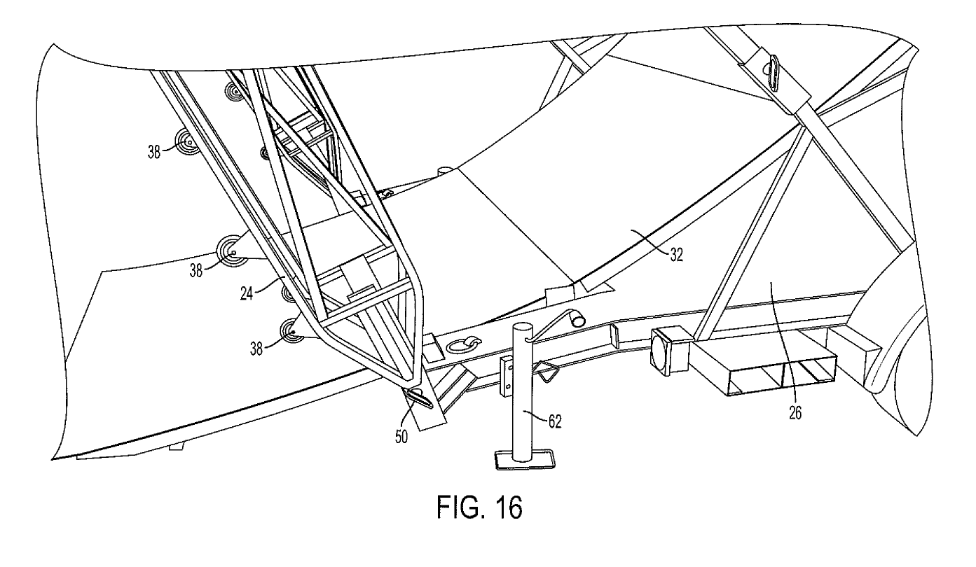

FIG. 17 is a view of the mobile bike swing disassembled and being loaded on a trailer.

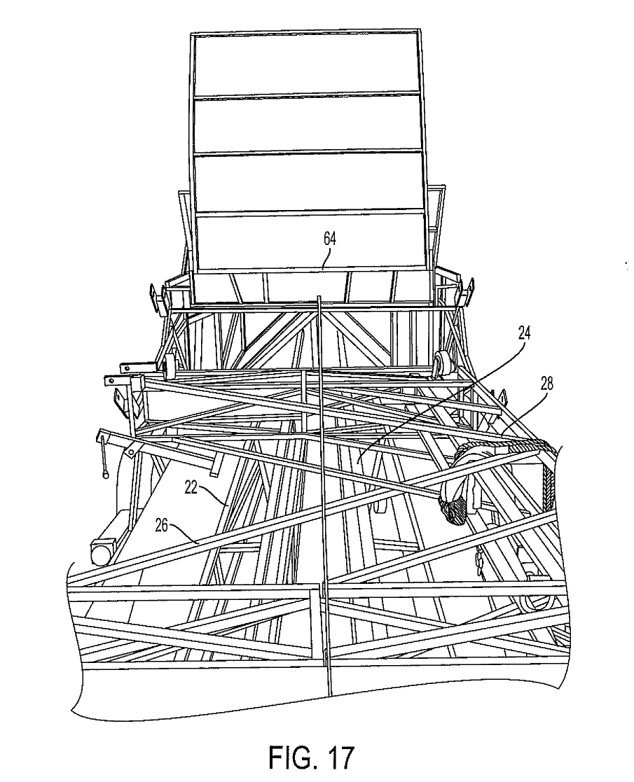

### DESCRIPTION OF THE EMBODIMENT(S)

Referring to the drawings, there is shown a mobile bike swing 20 and method for assembling the bike swing 20 according to an embodiment of the present invention. The mobile bike swing 20 of the present invention generally uses two crane like arms 22, 24 that hinge off the back of a trailer or base 26. These arms 22, 24 run parallel to one another, at about the width of the trailer 26, and have a top bracket 28 that connects them at the top end thereof. The mobile bike swing 20, when in a usable position, is attached to the trailer 26 on the bottom and angled at a predetermined angle with respect to the base or trailer 26, so that a rope, line or cable 30 secured to the top bracket 28 near a center point thereof, may hang freely several feet away from the base 26. In one contemplated embodiment, the distance from the base 26 to the free hanging line 30 is approximately three feet or more to ensure that someone may swing on a bike without hitting an arm 22, 24 or the base 26. The first 22 and second arm 24 also have a minimum distance between one another. In one contemplated embodiment four feet is the approximate distance between the two arms 22, 24. This is a critical measurement because it may allow someone to swing through the first and second arm 22, 24 without colliding into the arms 22, 24 while on the bike. The mobile bike swing 20 of the present invention may give the user the ability to swing both parallel and perpendicular to the trailer 26. Furthermore, extending from the back of the trailer 26 may be what is known as a quarter pipe or a first ramp 32. The quarter pipe 32, which is secured to the trailer 26 in conjunction with the bike swing on the trailer 26, may allow for the radius of the transition of the quarter pipe to be the same as the distance from where the rope 30 is tied on the top bracket 28 of the mobile bike swing 20 to the ground. This distance is important because it allows someone to ride on the ramp 32, hence increasing their height but maintaining the necessary tension on the rope 30 while riding the bike. The height of the arms 22, 24 and top bracket 28 of the mobile bike swing 20 may vary but in one contemplated embodiment is approximately twenty five feet from the ground when fully assembled. The mobile bike swing 20 of the present invention may also allow for riders of the bike swing to ride in both parallel and perpendicular directions with respect to the trailer or base 26. The mobile bike swing 20 uses a plurality of pins and hinges, which allows it to fold up and fit within the ramps that are attached to the base or trailer 26 of the present invention. This allows the mobile bike swing 20 to be portable and also allows it to be placed at various locations to entertain various types of crowds. Hence, the parallel arms 22, 24 of the bike swing 20 are angled at a predetermined angle with respect to the trailer 26 and ground on which the trailer 26 is arranged to allow a person on a bike to be secured within the swing and allow for a swinging motion both perpendicular and parallel with respect to the trailer 26 without colliding into the bike swing itself or any surrounding components.

The mobile bike swing 20 of the present invention is a collapsible portable device that has a swing hook 34 high enough on its structure, with the structure being sturdy enough to allow for swinging from the structure on the bike, thus eliminating the need for a tree such as that needed in the prior art. The present design of the invention is contemplated to have the two arms 22, 24 fixed at a predetermined angle off the back of a trailer or base 26 and the ground, this angle may be anywhere between 0° and 90° with respect to the trailer and the ground. In another contemplated embodiment the first and second arm 22, 24 of the mobile bike swing 20 are arranged five feet apart so that a rider can swing parallel to the trailer 26 and utilize the ramp 32 that is secured to the trailer 26 without running into the arms 22, 24 and swing in both a parallel and perpendicular direction with respect to the trailer 26. It should be noted that any angle may be used when doing the final installation and setup of the mobile bike swing 20 depending on the environment in which the mobile bike swing 20 is being used. In one contemplated embodiment, the mobile bike swing 20 has first and second arms 22, 24 which form two 90° angles at the top end thereof with a perpendicular top bracket 28. The top bracket 28 section may contain the hook 34 which is approximately located at the mid point of the top bracket 28. The hook 34 has a rope or any other type of cable 30 connected thereto. It should be noted that the arms 22, 24 may be angled from anywhere from between 0° to 90° with respect to the base 26 so that the structure may in fact have a different shape than that of a general rectangle as shown in the drawings. In other contemplated embodiments, the mobile base swing 20 may have a triangular shape, an arch like top bracket, and it is also contemplated to use just one arm offset to one side with a T like bracket extending therefrom or any other type of dual arm or multi arm set up to form the mobile bike swing 20 of the present invention. It is also contemplated to have the arms 22, 24, not parallel to one another, such that they may have any set up or shape that allows a rider to swing through the arms 22, 24 at or near the base 26 safely. It should further be noted that the mobile bike swing 20 may be used without any ramps or may have other ramps other than the ramps as shown in the figures. Hence, the mobile bike swing 20 may have any known design, such as rectangular, triangular, oval shaped, or any other design as long as it is capable of being placed at a predetermined angle with respect to the base 26, such that perpendicular and parallel swinging may occur with respect to the base 26 of the mobile bike swing 20.

The mobile bike swing 20 of the present invention generally includes a first arm 22 and a second arm 24, wherein the first arm 22 is parallel to the second arm 24. In one contemplated embodiment, the first arm 22 and second arm 24 may have a predetermined distance arranged therebetween. In one contemplated embodiment, the prearranged distance may be anywhere between four and five feet, however it should be noted that any distance between two feet and thirty feet may also be used between the arms 22, 24 of the mobile bike swing 20. Generally, the first and second arms 22, 24 have a lattice boom arm design which may include a plurality of metal tubes, pipes, beams or bars including a plurality of cross members, reinforcing members, support members and four main members of the lattice boom arm design. The lattice boom arm type design for the arms 22, 24 of the mobile bike swing create a robust structure that can handle the stresses of a large swing. Generally, the four main members of the arms 22, 24 are connected to each other with cross members, diagonal support members, etc. It should be noted that any design for the arms 22, 24 may be used. It is also contemplated to have a solid arm design. Generally, all of the members described herein are made of steel, however any other metal, ceramic, composite, plastic or natural material may be used. One end of the first and second arms 22, 24 generally may taper off to a point 36 which may allow for a predetermined pivot point to be defined at the bottom end of the first and second arms 22, 24 of the mobile bike swing 20. The arms 22, 24 are set at a predetermined height and/or length which allows for the bike rider to swing a predetermined distance with respect to the mobile bike swing 20. In one contemplated embodiment, the bike swing arms 22, 24 may be approximately twenty five feet in length, however it should be noted that the length may be anywhere from six feet to hundred feet depending on the bike swing and the design needed therein. It should also be noted that the first and second arms 22, 24 may include a plurality of wheels 38 arranged on a surface or component thereof. The wheels 38 may allow for the mobile bike swing 20 to roll along the ground before it is lifted into and secured in its fixed or final assembled position. The top end of the arms 22, 24 may have a plurality of male mounting members 40 secured to the end thereof. In one contemplated embodiment, there may be four male mounting members 40 secured to the each of the four main tubes or members of each of the first and second arms 22, 24. The male mounting members 40 may mate with and interact with female mounting members 42 secured to a first and second end of the top bracket 28 of the mobile bike swing 20. The top bracket 28 also has a generally lattice boom type design that includes a first, second, third, and fourth main bar member connected to one another by a plurality of cross members, diagonal support members and reinforcing bars. Generally, the top bracket 28 may have a U-shape. A top member 44 has a width of approximately four to five feet which mimics and matches the distance between the first and second arms 22, 24. The top member 44 of the top bracket 28 may have a first and second finger 46, 48 extending from the end thereof, wherein the fingers 46, 48 of the top bracket 28 may mate with the top ends of the first and second arm 22, 24 of the mobile bike swing 20. The female mounting members 42 may be arranged on the ends of the top bracket 28 and interact with the male mounting members 40 of the arms 22, 24. A plurality of pins 50 or any other fastening devices may be used to secure the female to the male mounting brackets of the first and second arm 22, 24 and top bracket 28 of the mobile bike swing 20. It should be noted that any other type of connecting device, such as a clevis, ring, bolt, screw, or any other fastener may be used to secure the first and second arm 22, 24 to the top bracket 28 of the mobile bike swing 20. It should be noted that the top bracket 28 may also include a plurality of diagonal support members arranged between the top member 44 of the top bracket 28 and a first and second finger 46, 48 extending down from the ends of the top member 44. The diagonal support members further reinforce the integrity and structural sturdiness of the top bracket 28 of the mobile bike swing 20. This may ensure that the top brackets of the mobile bike swing 20 does not twist due to the forces being place thereon by the bike rider swinging from the top bracket 28 of the mobile bike swing 20. It should be noted that the top member 44 may have any length depending on the width separating the first and second arm 22, 24 of the mobile bike swing 20. It should further be noted that both the first and second arm 22, 24 and the top bracket 28 generally are formed of a steel material, however any other metal, ceramic, composite, plastic, or natural material may be used to form the first and second arm 22, 24 and top bracket 28 of the mobile bike swing 20. It should further be noted that in one contemplated embodiment the first and second arm 22, 24 and top bracket 28 are made by welding together the bars, pipes, beams, cross members or reinforcing bars by any known welding technique or may be bolted together or use any other mechanical fastening or chemical fastening technique used to create the first and second arm 22, 24 and top bracket 28. It should further be noted that it is also contemplated to have the first and second arm 22, 24 extend all the way to the top of the mobile bike swing 20 and have a single straight top bracket 28 connected directly to the top end of the first and second arm 22, 24 of the mobile bike swing 20 without having a U-shaped top bracket 28 as also described herein. It should be noted that the male and female portions of the mounting brackets may be reversed, such that they occur on the top bracket 28 and the end of the first and second arm 22, 24 in the opposite manner than that described herein.

It should also be noted that the top bracket 28 may include a plurality of storage connecting members 52 which may be used to interact with a plurality of the mounting brackets 42 arranged on the end of the first and second arm 22, 24. This may allow for the top bracket 28 to be stored and secured to the end of the first and second arms 22, 24, which are placed next to each other, in order to store the mobile bike swing 20 on the trailer/base 26 for movement of the trailer of the mobile bike swing 20 to a new location. In this embodiment, four storage connecting members 52 are used on one of the fingers extending from the top member 44 of the top bracket 28 and will interact with and interengage with four of the mounting brackets and be pinned or secured via any known fastener, thus allowing for the top bracket 28 to be folded onto, via pivoting action, to a surface of the first and second arm 22, 24 in order to be stored on the trailer/base 26.

The first and second arm 22, 24 on the bottom end thereof reduces to a point 36, wherein that point 36 on the end has a orifice 54 therethrough. The orifice 54 may align with an orifice in a female securing bracket 56 arranged on one side of the base 26. The male point 36 portion of the end of the first arm 22 may be arranged within the female securing bracket 36 with a pin or suitable fastener 50, thus creating a secure pivotal connection between the first arm 22 and the base 26. The same may occur with the bottom end of the second arm 24 on the opposite side of the base 26. A female securing bracket 56 may receive the bottom end of the second arm 24 and a pin or other fastener 50 may be arranged through both orifices thus pivotally securing the second arm 24 to the base 26. After securing the bottom ends of the first arm 22 and second arm 24 to the base 26, the two arms 22, 24 will be parallel to one another. In one contemplated embodiment, the distance between the first and second arm 22, 24 is generally between four and five feet, but may be anywhere between two feet and thirty feet. It should be noted that any of the connecting pins or fasteners 50 described herein may have any type of securing mechanism thereon, such as a pin, screw, ring clasp, or a spring loaded locking mechanism or any other method of ensuring that the pin 50 will not disengage from the orifice during use of the mobile bike swing 20. It should further be noted that an outside surface of both the first and second arms 22, 24 may include a plate or other flat surface 58 which is capable of having advertisement thereon. In one contemplated embodiment, metal plating 58 is used with the first and second arm 22, 24 of the mobile bike swing 20. The plate 58 may be bolted on or secured via any other known mechanical or chemical fastening technique to the outside surface of the arm 22.

The top bracket 28 of the mobile bike swing 20 also may include a hook 34 located at a generally top center portion of the top bracket 28. The hook 34 may be made of any known material, such as metal, ceramic, plastic, composite or natural material. The hook 34 may also include a lever mechanism to ensure that the rope or cable 30 never disengages from the hook 34. It is also contemplated that the hook 34 may have a 360° swivel connection to the top bracket 28 to ensure the hook 34 allows the swinger to move in both a perpendicular and parallel direction with respect to the base 26 of the mobile bike swing 20. It is also further contemplated to have a plurality of hooks 34 located along a plurality of points along the top bracket 28 to allow for multiple ropes 30 to be hung from the mobile bike swing 20. This may allow multiple bike riders to perform tricks at the same time with the mobile bike swing 20. It should further be noted that any type of hook or connecting mechanism, such as an eyelet may also be used to connect the rope or cable 30 to the mobile bike swing 20. It should be noted that any known rope, line, cable 30 or the like may be used to tie through and secure to the hook 34 of the mobile bike swing 20. The rope, line or cable 30 may include a premade loop at the end thereof, with the loop over the hook 34 of the mobile bike swing 20 or may be able to pass directly through the hook 34 and connect on both ends to the harness 60 of the bike swing 20. The harness 60 of the bike swing 20 is attached at one end of the rope or cable 30 of the mobile bike swing 20. The harness 60 may be made of any known material, such as a cloth, plastic, composite, metal, any natural material, or any other known material. Generally, the harness 60 has a circular or oval shape, but any other shape may be used. It is also contemplated to use an old tire as the harness 60 for the mobile bike swing 20. The harness 60 may have a stiff or rigid surface or a pliable surface such that it is easier to use and more comfortable for the bike rider using the mobile bike swing 20. It is also contemplated to use a jacket type harness to connect the biker to the mobile bike swing 20.

The mobile bike swing 20 also includes a base 26. The base 26 may be made of any known structure that is capable of being moved into a predetermined position and location. The base 26 may be made of any known material but in one embodiment is made of steel, however, any plastic, ceramic, natural material, metal, etc., may also be used for the base 26. In one contemplated embodiment, the base 26 may be a trailer that is capable of being towed by a vehicle. In the embodiment shown in the figures, the trailer 26 is a dual axle trailer made of a metal. The base 26 may also included a plurality of support stands or jacks 62 connected to the base 26 on each side thereof. In one contemplated embodiment, the support stands 62 may be in the form of an automotive type jack. The support stands 62 may be rotated into position via the flanges attached to the trailer or base 26. The use of the jacks 62 which may engage with the surface on which the trailer and the arms 22, 24 are arranged may make the swing 20 more sturdy and stable during use of the swing 20. In one embodiment a locking mechanism, such as pins, may secure the jack 62 in its proper position with respect to the trailer 26 and the ground to which it is engaged. The jacks 62 may pivot into a stowed position during movement of the mobile bike swing 20 to a different location. It should further be noted that the base 26 may include a lifting mechanism 64 inside a portion of the base 26. In one contemplated embodiment, a 6000 pound winch 64 which is hooked to a deep cycle battery is used. However, the winch 64 may be gas or hooked up to any other type of power source to allow the winch 64 to operate. In one contemplated embodiment, the winch 64 is used to lift the mobile bike swing 20 to a proper angle for use. Also, the winch 64 may have a cable with a hook one the end and that hook may interact with the swing hook 34 in order to lift the mobile bike swing 20 to its appropriate height. The winch 64 may also be used to lift or move the disassembled mobile bike swing 20 onto the base or trailer 26 via the wheels 38 attached to the first and second arm 22, 24 and the top bracket 28.

The mobile bike swing 20 also may include a plurality of mounting brace members 66 arranged between the first arm 22 and the base of the mobile bike swing 20 and a second arm 24 and the base 26 of the mobile bike swing 20. In one contemplated embodiment, a total of four mounting brace members 66 may be used to secure the first and second arm 22, 24 into the final assembled position. The brace members 66 generally are steel beams having a generally square cross section. However, any other shaped pole, rod or bar made of any known metal, composite, ceramic, plastic, or natural material may be used depending on the design requirement for the mobile bike swing 20. Generally, one of the mounting brace members 66 is arranged near a mid point of the fully assembled arms 22, 24 and top bracket 28 and near or adjacent to a top edge of the fully assembled arms 22, 24 and top bracket 28. The mounting brace members 66 are secured via any known fastener, such as a nut and bolt, or any other type of locking pin or mechanism. The braces 66 are pivotally connected to the first and second arms 22, 24 and then connected to a female brace bracket 68 secured to the base 26 near a portion of the ramp 32 thereof. Therefore, each end of the brace member 66 has an orifice therethrough that may allow a fastener to pass therethrough and through the mounting brace bracket 68. Therefore, with the mounting braces 66 pivotally connected to the arms 22, 24 it may allow for the mounting braces 66 to be aligned to the female mounting brace brackets 68, on the base 26 and thus hold the fully assembled and raised mobile bike swing 20 at its predetermined angle for use.

The mobile bike swing 20 may also include at least one ramp 32 in the form of a quarter pipe. The ramp 32 may be arranged between the first and second arm 22, 24 of the mobile bike swing 20. In one contemplated embodiment, the ramp 32 may be separate into three separate portions or components that are all pivotally mounted to the base 26 thus allowing for storing of the mobile bike swing 20 in its disassembled position therein. It should further be noted that it is also contemplated to have just a single piece or any other number of pieces for the quarter pipe ramp 32 which is arranged between the first and second arm 22, 24 secured to the base 26. It should be noted that the ramp 32 may be made of any known material, such as metal, ceramic, plastic, composite or any other known material. The ramp 32 may also have a predetermined surface thereon, such as a grit or other nonslip surface for better traction for the bike riders. It is also contemplated to have a second ramp 70, secured to the base 26, which is placed perpendicular to the first ramp 32. Therefore, the two ramps 32, 70 would form a generally T shape when viewed from above. The ramp 70 that runs perpendicular to the first ramp 32 of the mobile bike swing 20 usually is used for bike tricks to occur thereon while the bike swing is being used by another bike rider. The ramps 32, 70 may also be comprised of several components or pieces, such that they may be folded and stored on the base/trailer 26 for movement to any location along with the mobile bike swing 20.

In operation, the mobile bike swing 20 may be driven by any known vehicle by connecting the trailer/base 26 to a vehicle and arranging the base 26 in a predetermined position for the audience to watch the bike performers perform. After moving the portable mobile bike swing 20 via the trailer 26 to its predetermined position, the first ramp 32 of the mobile bike swing 20 is extended from the back to back of the trailer 26 such that a first section or lower section of the first ramp 32 may be removed from the trailer 26 and placed on the ground. Next, in the embodiment shown, another portion of the first ramp 32 may be raised to a temporary position and is secured during removal of the mobile bike swing 20 from the trailer 26. It should be noted that all of the ramps 32, 70 have a plurality of brackets arranged thereon in order to secure the ramps 32, 70 in predetermined positions, either during operation of the bike swing, or during the assembly or disassembly of the bike swing from or onto the trailer 26. Next, the first and second arms 22, 24 of the mobile bike swing 20 are rolled out of the trailer 26. In the embodiment shown, the two arms 22, 24 of the mobile bike swing 20 rolls on and off the trailer 26 and have the top bracket 28 engaged with a surface thereof via a pivotal connection as described above. Hence, in one contemplated embodiment, three pieces form the mobile bike swing 20 main body. It should be noted that it is contemplated to have just one piece or two pieces or maybe more than three pieces to create the mobile bike swing 20 of the present invention. After the first and second arm 22, 24 are rolled off the trailer 26, the top bracket 28 is pivoted down onto the ground via the four pins that act as a hinge to store the mobile bike swing 20 in its disassembled position. After the top bracket 28 is placed on the ground all of the pins 50 are removed thus disconnecting the top bracket 28 from its stored position on the first and second arm 22, 24. Next, the top bracket 28 and the first and second arm 22, 24 may be assembled into the assembled final position.

To secure the top bracket 28 to the first and second arms 22, 24, the top bracket 28 is aligned such that the first and second fingers 46, 48 of the top bracket 28 align with the top ends of the first and second arms 22, 24. The mounting brackets 42 on each of the arms 22, 24 may align with each of the fingers 46, 48 of the top bracket 28. A total of eight pins or fasteners 50 may be used to secure the first and second arm 22, 24 to the top bracket 28. The female portions of the mounting brackets 52 may receive the male portions of the mounting brackets 42 and then a pin 50 may be inserted through the orifices of both the female and male portions of the brackets thus securing the first and second arm 22, 24 to the two fingers 46, 48 of the top bracket 28. In one contemplated embodiment, the mounting brackets 42 may fit inside the flanges 52 and then have a ⅝ inch pin 50 placed through all four of the brackets on each side for a total of eight inserted pins 50. After this step, the mobile bike swing 20 structure, via the eight pins 50 may be stationary with no moving parts. It should be noted that any other number of or size pin 50 may be used to secure the first and second arm 22, 24 to the top bracket 28. After both arms 22, 24 are secured to the top bracket 28, the trailer 26 may be connected to the first and second bottom end of the arms 22, 24. The ends 36 are arranged within the connecting brackets 56 on each side of the trailer 26, such that the male portions 54 of the first and second arms 22, 24 may be received in the female bracket 56 of the trailer 26 and an appropriate fastener in the form of a pin, dowel, bolt, or the like 50 may be arranged therebetween. This may create a pivotal connection between the mobile bike swing 20 and the trailer 26. It should be noted that two pins 50 are used to connect each side of the bottom end of the arms 22, 24 to the respective two female mounting brackets 56 attached to the trailer 26 on each side thereof. Therefore, a total of four pivotal connection points and four fasteners 50 may be used to secure the mobile bike swing 20 to the trailer 26. Next, the middle portion of the first ramp 32 may be secured into its position. Next during assembly of the mobile bike swing 20, the winch cable may be connected to the hook 34 located generally at a center of the top bracket 28 and the first and second arms 22, 24 may be lifted to its raised or fully assembled position, via the winch mechanism. Then the mobile bike swing arms 22, 24 may be raised via the pivot point 36 connected at the trailer 26 to its fully raised position. Hence, in its fully raised position the mobile bike swing 20 may have a predetermined angle between the ground and the trailer 26 to which it is pivotally connected. In one contemplated embodiment, an angle of 0° to 120° may be used depending on the environment in which the mobile bike swing 20 will be used. After the mobile bike swing 20 is raised to its required position and height and while the winch 64 is still engaged, the brace members 66 may be attached to the mounting brackets 68, via any known fastener. In one contemplated embodiment, a plurality of pins 50 are arranged through the orifices of the mounting brace members 66 and through the orifices of the female mounting brackets 68 arranged on the trailer 26 near the side of the arms 22, 24. The winch 64 is used to adjust the swing structure 20 until the orifices align with the four mounting brace members 66 and the female mounting brackets 68 of the trailer 26. Once the mounting braces 66 are secured into place between the first and second arms 22, 24 and the trailer 26, the winch 64 cable may be loosened and placed into a neutral position during operation of the mobile bike swing 20. The winch 64 cable generally is placed and temporarily stored through one of the arms 22, 24 of the mobile bike swing 20. Next, a third portion or top portion of the first ramp 22 is lowered into position and secured via its pin and mounting brackets. Next, a second ramp 70 is lowered and secured into place perpendicular to the first ramp 32 of the mobile bike swing 20. Then, supporting stands or automotive jacks 62 may be moved into position on each side of the trailer 26 with respect to the ground on which the trailer 26 is arranged. The jacks 62 may be rotated into position or moved into position via any known methodology and secured such that the trailer 26 and jack 62 interact and engage with the ground, such that the jack 62 is secured to the trailer 26 and engages with the ground, thus providing a sturdier base for the mobile bike swing 20 to be operated thereon. To disassemble the mobile bike swing 20 all of the steps are done in reverse and the arms 22, 24 are either rolled onto the trailer 26 manually or the winch 64 may be used to roll them on the trailer 26. Then the first and second ramps 32, 70 are folded over the top and the mobile bike swing 20 is capable of being connected to a vehicle and driven to another location for use.

The present invention has been described in an illustrative manner. It is to be understood that the terminology which has been used is intended to be in the nature of words of description, rather than that of limitation.

Many modifications and variations of the present invention are possible in light of the above teachings. Therefore, within the scope of the appended claims, the present invention may be practiced otherwise than as specifically described.

What is claimed is:

1. A mobile bike swing, said bike swing comprising:
a base;
a first arm pivotally connected to said base;
a second arm parallel to said first arm and having a predetermined distance therebetween, said second arm pivotally connected to said base;
a bracket arranged between said first arm and said second arm;
a hook arranged generally at a center point of said top bracket; and
a line connected to said hook.

2. The swing of claim 1 wherein said base is a towable trailer.

3. The swing of claim 1 further comprising at least one ramp secured to said base.

4. The swing of claim 1 further comprising a winch connected to said base.

5. The swing of claim 1 further comprising a mounting brace member connected between said first arm and said base.

6. The swing of claim 1 further comprising a mounting brace member connected between said second arm and said base.

7. The swing of claim 1 wherein said line having a harness at an end thereof.

8. The swing of claim 1 further comprising a support stand connected to said base.

9. The swing of claim 3 further comprising a second ramp, said second ramp is connected to said base and is perpendicular to said ramp.

10. The swing of claim 1 further comprising at least one wheel connected to said first arm.

11. The swing of claim 1 further comprising at least one wheel connected to said second arm.

12. The swing of claim 1 wherein said top bracket having generally a U-shape.

13. A method of erecting a mobile bike swing, said method comprising the steps of:
positioning a bike swing base at a predetermined position;
unloading a first and second arm from said base;
unloading a top bracket from said base;
connecting said top bracket to said first and second arm;
pivotally connecting said first and second arm to said base;
raising said first and second arm to a predetermined height and angle with respect to said base; and
connecting a mounting brace between said first arm and said base.

14. The method of claim 13 further comprising the step of connecting a mounting brace between said second arm and said base.

15. The method of claim 13 wherein said base is a trailer.

16. The method of claim 13 further comprising the step of deploying a ramp from said base, said ramp is arranged between said first and second arm.

17. The method of claim 16 further comprising the step of deploying a second ramp from said base.

18. The method of claim 17 wherein said second ramp is arranged perpendicular to said ramp.

19. The method of claim 13 further comprising the step of connecting a line to said top bracket.

20. The method of claim 13 further comprising the step of installing a support stand between said base and a surface said base rests on.

21. A mobile bike swing comprising a movable trailer and a bike swing body connected to said trailer.
